(19) United States
(12) Patent Application Publication
(10) Pub. No.: US 2026/0194408 A1
(43) Pub. Date: Jul. 9, 2026

(54) MODULAR INLINE INSPECTION VEHICLE

(71) Applicant: DarkVision Technologies Inc., North Vancouver (CA)

(72) Inventor: Jay Roderick Hope, Vancouver (CA)

(21) Appl. No.: 19/132,834

(22) PCT Filed: Dec. 15, 2023
(86) PCT No.: PCT/IB2023/062800

§ 371 Date: May 26, 2025

(30) Foreign Application Priority Data
Dec. 15, 2022 (GB) 2219001.1

(51) Int. Cl. G01M 3/00

(52) U.S. Cl. CPC G01M 3/005

(57) ABSTRACT

An Inline Inspection Tool is provided to image a pipeline as it travels through it, in order to assess damage of the pipeline, such as cracks, leaks and weld problems. The tool is created from several stacked sensor modules removably connected to each other. Each module provides imaging of a certain section of the pipeline and then multiple imaged sections may be combined to visualize the entire pipeline. This creates a versatile tool that can be customized onsite for each job, using different sensors or imaging modes.

### RELATED APPLICATIONS

This International PCT Patent Application claims the benefit of priority to United Kingdom Application No. 2219001.1, filed on Dec. 15, 2022. The above-referenced patent application is herein incorporated by reference in its entirety.

### TECHNICAL FIELD

The present disclosure relates to inline inspection for pipelines in particular gas or liquid pipelines for long distance transportation that require inspection for defects.

### BACKGROUND

It is common practice in pipeline operation to have pipelines inspected on a regular basis to check for cracks, dents, or other defects. Inline inspection vehicles, AKA Pigs, move inside the pipelines, using a range of sensor technologies to detect flaws on the internal surface of the pipeline. This is needed to prevent environmental disasters that would occur if the fluid were to escape.

Inline inspection vehicles are normally assembled in a warehouse and set for the life of the vehicle, barring any problems. If there are problems, the whole vehicle is dissembled, fixed and reassembled. There is little option to configure these vehicles in the field or fix parts without taking everything apart.

### SUMMARY

According to one aspect of the disclosure there is provided an Inline Inspection Tool comprising: a plurality of stacked sensor modules removably connected to each other; sealing means between adjoining modules to prevent ingress of external fluid into the tool; one or more sensors mounted with each module, facing radially outward; and electronics for operating said sensors and receiving data from said sensors, wherein the stack of modules is respectively arranged with said sensors circumferentially distributed around the tool.

The tool may comprise a mandrel or other connection means running longitudinally through the plural sensor modules to bring the sensor modules together to create a sealing force between the sensor modules and sealing means.

The tool may comprise a separate battery vehicle mechanically and electrically connected to the plural sensor modules.

At least some of the sensors may be mounted at distal ends of arms that extend away from the sensor modules

Sensor modules may comprise at least two imaging sensors, preferably located diametrically apart.

The imaging sensors may be one of: MFL, Calipers, EMAT, Ultrasonic, Phased Array Ultrasonic, or optical.

Mating surfaces of adjoining sensor modules may be stackable with a variable rotational offset between them.

The tool may comprise an indexer for stacking adjoining sensor modules at one of a selection of fixed rotational offsets.

The sensor modules are substantially disc shaped and create a generally cylindrical tool when stacked.

Each module may comprise data storage, sensor driving circuits and communication means to operate independent of other sensor modules.

The tool may comprise heat sinks thermally coupling the electronics to an exterior of said sensor modules.

The tool may comprise at least six sensor modules.

A method of performing inline inspection of a pipeline comprising: selecting a plurality of sensor modules, each module mounted with at least one imaging sensor facing radially outwards; creating an inline inspection tool by stacking the plurality of sensor modules together with said sensors circumferentially distributed around the inline inspection tool; sealing adjoining modules to prevent ingress of external fluid into the inline inspection tool; deploying the inline inspection tool into and through the pipeline; and autonomously operating electronics within the inline inspection tool to receive and store data from said sensors.

The method may swap one of the sensor modules in the inline inspection tool for another sensor module at a deployment site.

The sensors may be circumferentially distributed around the inline inspection tool by stacking the plurality of sensor modules together with fixed rotational offset between adjoining modules. The fixed rotational offset may be selected based on the number of sensors used in the tool.

The method may insert a mandrel through the plurality of sensor modules and tightening it against ends of the sensor modules to increase a sealing force between adjoining modules.

Thus the inventive concept provides an ILI vehicle that can be rapidly changed or modified for a particular job, without having to rebuild the entire vehicle, which would usually be done at the warehouse. Here several modules can be put together as needed for particular job with each module independently looking after its own functions.

### BRIEF DESCRIPTION OF DRAWINGS

The disclosure may be illustrated with reference to the attached drawings in which like references refer to like objects. The drawings are not necessarily to scale emphasis being placed on illustrating the concepts and details of preferred embodiments.

FIG. 1A is a perspective view of plural modular discs making up an inline inspection sensor vehicle of a preferred embodiment.

FIG. 1B is a perspective view of the plural modular discs from the opposite end.

FIG. 2A is a top view of stacked modules with sensor arms.

FIG. 2B is a perspective view of stacked modules with fixed sensors.

FIG. 3 is an exploded view showing two modules for sealed assembly with a central mandrel.

FIG. 4 is a cut-away view of a battery vehicle and imaging vehicle.

FIG. 5A is an exploded side view of modules with clocking rim.

FIG. 5B is an exploded perspective view of modules with clocking rim.

FIG. 6 is a perspective view of a sensor arm.

FIG. 7 is an illustration of assembly steps for a sensing module.

FIG. 8 is an exploded diagram of a sensing module.

FIG. 9 is a flowchart for modifying and operating an inline inspection tool.

### DETAILED DESCRIPTION

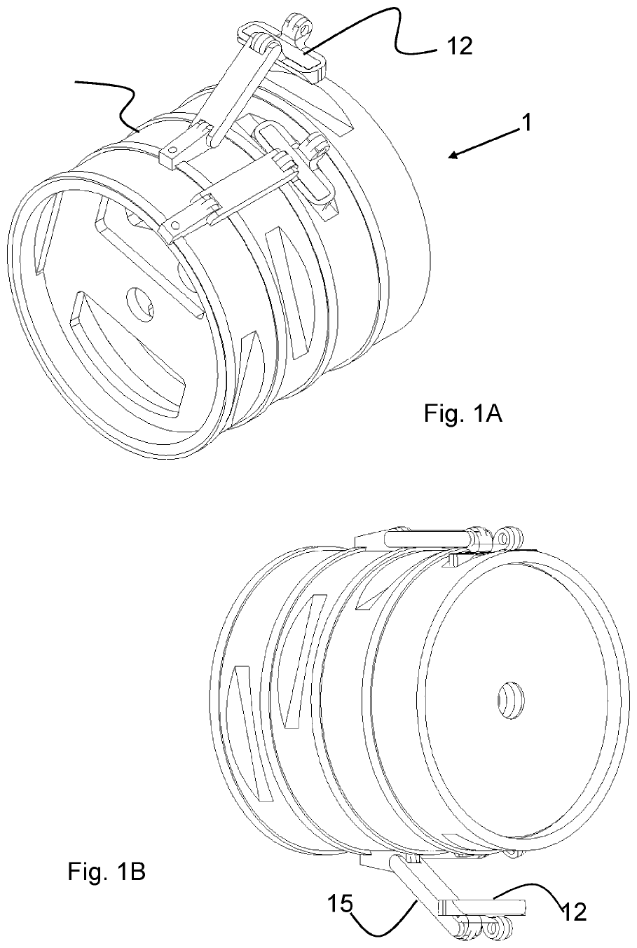

The disclosure may be illustrated by the attached drawings of preferred embodiments. With reference to FIGS. 1A and 1B there is provided an inline inspection vehicle 1 having swappable, configurable sensor modules 10. The sensor vehicle comprises a plurality of modular discs, which stack together, typically in a rotationally offset fashion to create a helical arrangement of sensors 12.

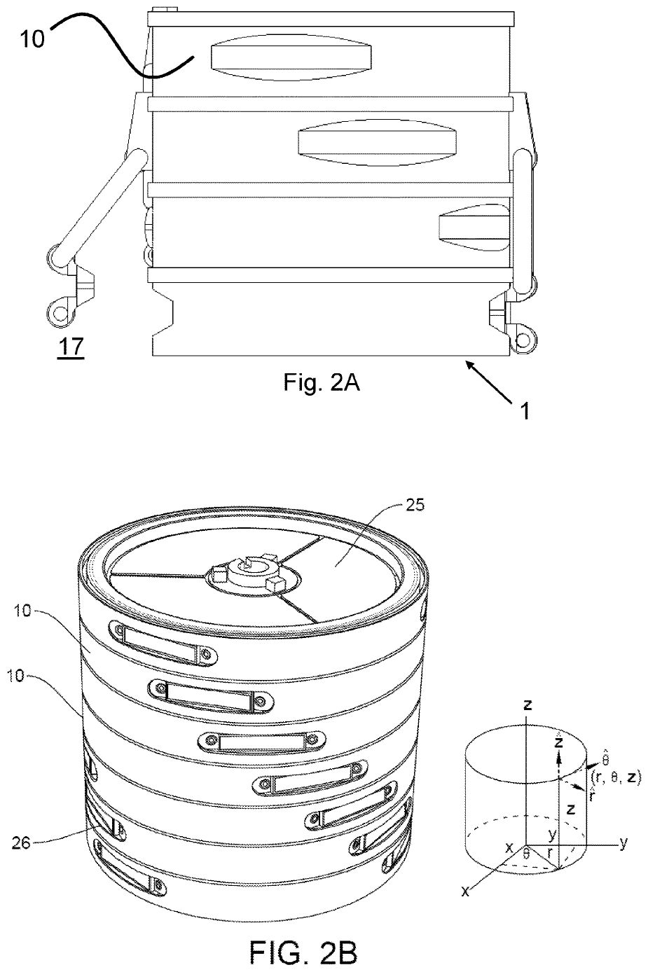

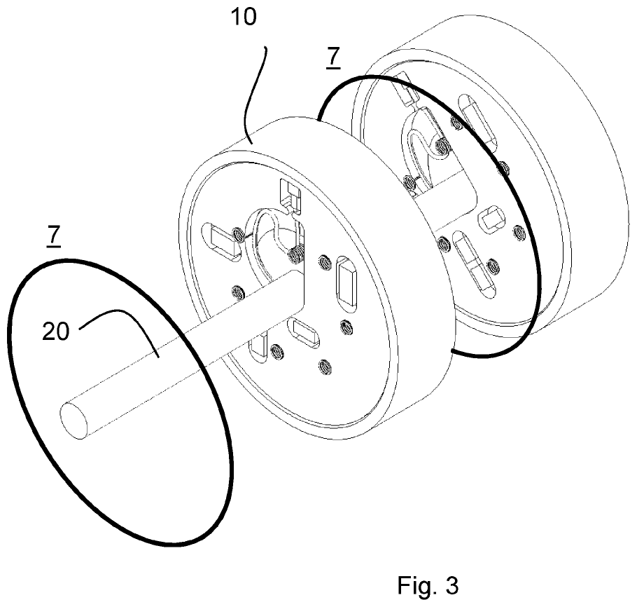

As shown in FIG. 2A, a sensor arm 15 may be used to move the sensor 12 towards the inner surface of the pipeline, making contact at wheels 17 or retract to the tool housing when the inspection vehicle moves around bends and restrictions in the pipeline. FIGS. 3A and 3B shows how the modules are stacked with adjacent modules sealed at their peripheral junction by seal 7 and then compressed together by a central mandrel 20 that passes through all the modules and end caps. Alternatively adjacent modules may be bolted together at flanges or screwed into each other using male/female sides of the disc with a seal therebetween.

Each sensor module is preferably self-sufficient, containing the sensors, electronics, memory and heat exchange assemblies for itself, while being connectable to a central module for overall control and data upload to a remote computer. In such a design, sensor modules may be selected, removed, tested, modified for a particular inspection job simply by removing the connection mandrel and swapping or modifying a single sensor module, rather than dissembling and modifying an entire vehicle. For example, a defective module can be swapped out with a new module in the field, while the defective module is separately tested for the problem. The remaining modules do not rely on other modules physically or electronically to operate.

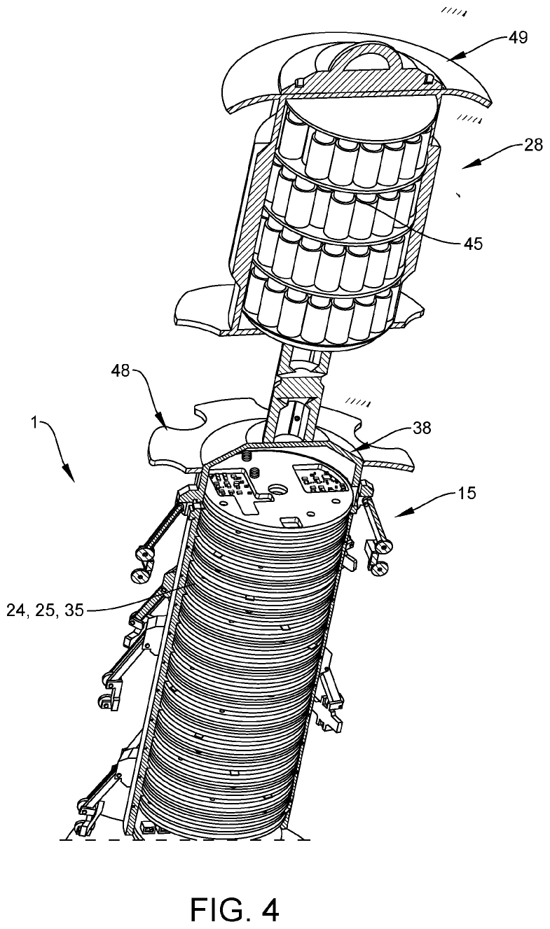

The overall inline inspection vehicle 40 may include several sensor vehicles 1, drive cups 49 for propelling the vehicles using fluid flow and differential pressure, centralizer discs 48 for keeping the vehicles centered within the pipeline for imaging quality, a power vehicle 28 holding batteries 45 that power the sensor modules, and a control module 30 that dictates what imaging modes are performed and then when to transfer data from each of the sensor modules during upload at the end of the job. FIG. 4 shows a cutaway view of this overall tool. A cutout in the middle of each sensor module's circuit board allows both the mandrel and cabling to pass therethrough. The cabling connects at the control module and every sensor module's circuit board and also connects to the power module.

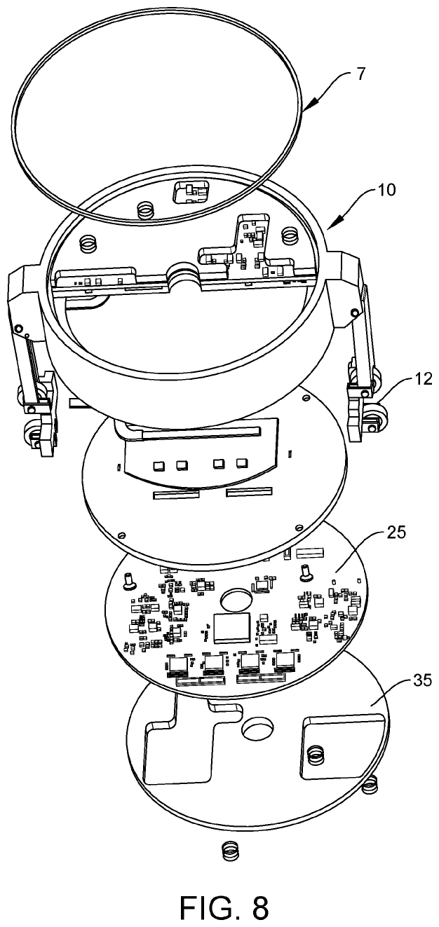

As shown in exploded FIG. 8, a single sensor module may comprise a peripheral housing, sealing 7, circuit boards 25, imaging sensors 12, data storage, and a heat sink 35. A central opening is provided in these elements, through which the mandrel and cabling can pass. The heat sink is in thermally conductive contact with a) the circuit board, particularly exothermic elements such as computing chips and the b) the housing to move heat from the circuit to the fluid in the pipe. Conductive heat paste may be used to improve the heat transfer.

The mandrel 20 with fastening ends passes through each of the sensor modules and terminate at end caps 38 of the tool, where fasteners are tightened to pull the sensor modules together into sealing contact. The mandrel may comprise a lead screw and nut which tightens to bear upon the end caps.

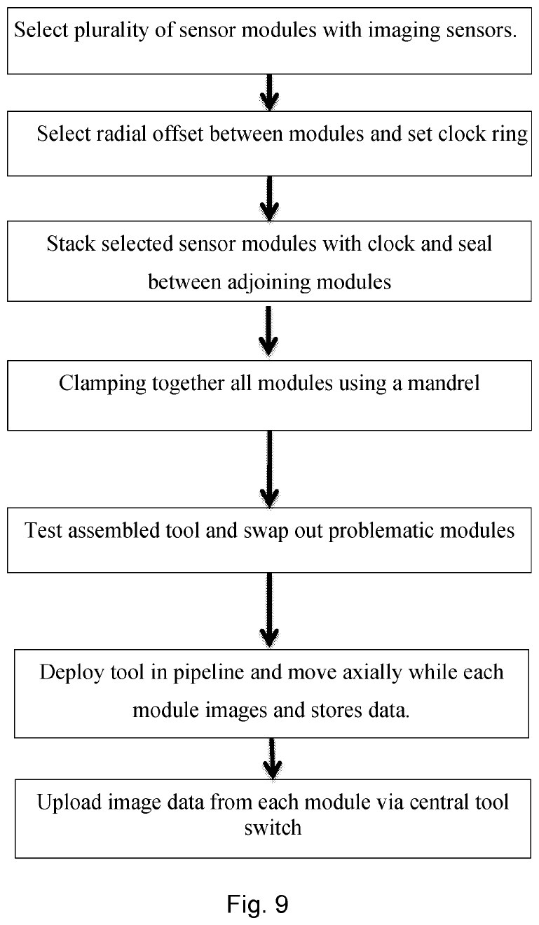

A sealing gasket 7 located between adjoining modules at their periphery provides the fluid sealing function. There may be a groove in one or both mating faces of the sensor modules to retain the gasket or O-ring. When the mandrel is tightened each gasket forms a seal against the faces of adjacent modules'housing. As shown in the cross-sectional view of FIG. 9, a periphery on one side of the sensor module has a groove or recess to hold and support a seal (e.g. gasket or O-ring), while the periphery on the other side is shaped to engage the seal, preferably in a crush seal arrangement.

Each sensor module 10 comprises one or more imaging sensors 12 for inspecting the pipeline for defects. The sensors may be ultrasound, mechanical caliper, Magnetic Flux Leakage (MFL), Electromagnetic Acoustic Transducer (EMAT) or other commonly used imaging technology. In a preferred embodiment, a phased array ultrasound sensor is used.

The sensors may be mounted on a movable arm 15, biased outward to urge upon the surface of the pipeline and deflect for dents and bends as it moves therethrough. There may be plural sensor probes on a single sensor module, preferably spaced apart to avoid crosstalk. As shown in FIGS. 2A and 8 there may be two diametrically opposed imaging sensors per module. The overall inspection vehicle may comprise a mix and match of different sensor types, highlighting another benefit of this modular design.

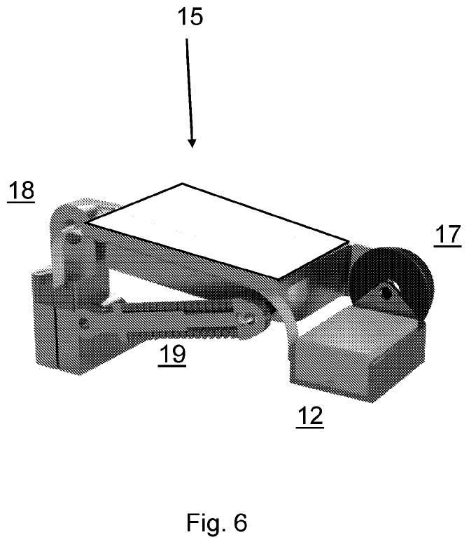

Rotatable sensor arms allow the sensor to closely inspect the surface of the pipeline while accommodating dents, diameter changes and bends in the pipeline. As shown in the cut-away of FIG. 6, each arm 15 may comprise imaging sensor 12, pipeline engaging wheel 17, and biasing spring 19.

In order to inspect the entire circumference of the pipeline, there may be several sensors 12 in a staggered arrangement, such as the helical arrangement shown in FIG. 2B. For example, there may be six sensor modules 10, each with two sensors 12, each sensor inspecting a 30 degree-wide arc, in order to inspect the full 360° circumference of the pipeline. Adding more modules allows for some sensing overlap and data redundancy.

The sensor modules are fixed to their neighboring module but rotationally offset to provide this circumferential coverage. In one embodiment the rotational offset is variable to allow the operator to customize the coverage and or overlap of sensor sweeps. In another embodiment the rotational offset uses an indexer having plural selectable, discreet angles. The indexer may be a locating pin or mating features in the faces of the modules to ensure a fixed offset. Orientation sensors on each module, such as gyroscopic or accelerometers may be used to determine the relative or absolute orientation of a given module, which is stored with the sensor data. This orientation may be used by the controller of each module to set its own imaging parameters or by offline imaging processors to recreate an image of the pipeline for a sensor log at this known orientation.

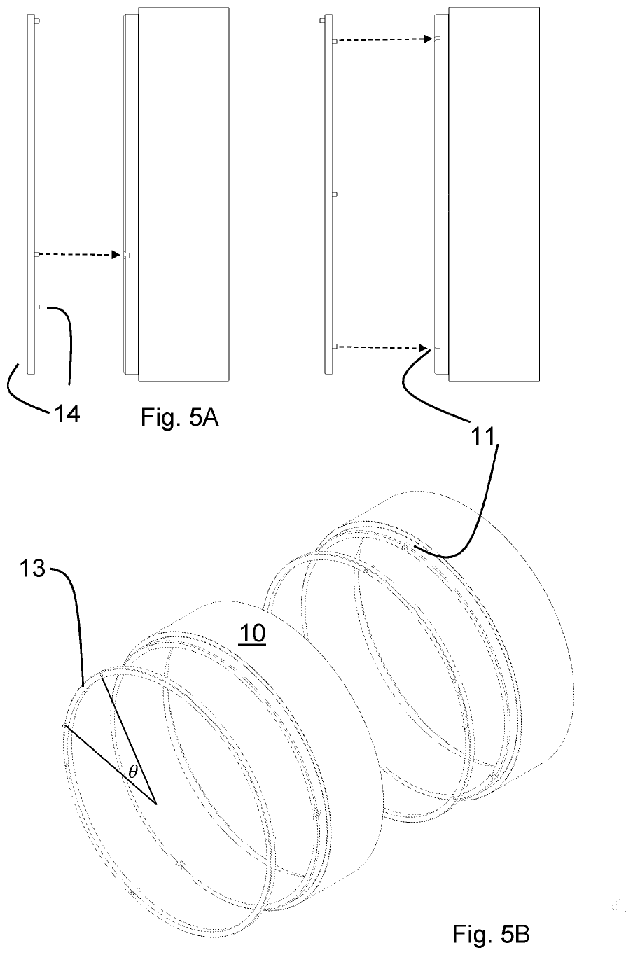

The periphery of each module is shown in the drawings as circular but other shapes may provide a similar function. So, while a circle provides the most straightforward solution for rotational and infinitely variable offset, other shapes, such as an octagon, would also provide a fixed incremental offset between adjoining modules. FIG. 5 shows two sensor modules (exploded) with a clocking ring 13 therebetween, which ring engages faces of the sensor modules in a protrusion and recess arrangement. In this embodiment, one side of the clocking ring has plural first locating protrusions 14 that are symmetrically arranged (e.g. three pins that are 120° apart). This side engages identically arranged first recesses 11 on a first sensing module. The other side of the clocking ring has one or more offset locating protrusions (i.e second locating protrusions) that are engage with second recesses on a second sensing module but rotationally offset with respect to the first locating protrusions by θ, where θ is typically between 15° and 45°. This provides a fool-proof way to assemble sensor modules with the predetermined, fixed offset.

The skilled person will appreciate that locating protrusions and locating recesses may be reversed between the ring and module, and also that many shapes may be used that cooperate with each other to locate adjacent modules. Alternatively the sensor modules'faces themselves may have contours, ridges, or protrusions/recesses that allow adjacent faces to cooperate in a rotationally offset arrangement,

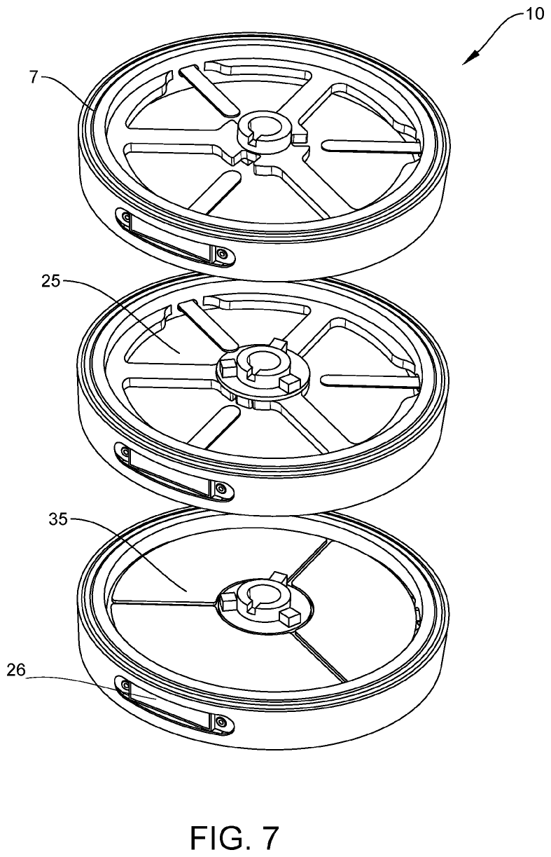

The housing of each sensor module provides the structure and strength to contain the electronics therein in a pressurized environment. The housing is thermally conductive to remove heat from the electronics. As shown in FIG. 7, the housing maybe designed as a thin wall with spokes and central hub, which provides the radial strength and contact area for the heat sink. Thus the housing is preferably made of metal.

The drive and centralizing disks maybe of design and construction commonly used in inline inspection vehicles. These are typically made of urethane and shaped to maintain a differential pressure between aft and the forward regions of the vehicle to propel the vehicle while centralizing the imaging sensor within the pipeline. Similar to other Inline Inspection tools (aka inspection PIGs), the present tool may include urethane drive cups for propulsion and centralizing.

1. An Inline Inspection Tool comprising:
a plurality of stacked sensor modules removably connected to each other;
seals between adjoining modules to prevent ingress of external fluid into the tool;
one or more sensors mounted with each module, facing radially outward; and
electronics for operating said sensors and receiving data from said sensors,
wherein the stack of modules is arranged with said sensors circumferentially distributed around the tool.

2. The tool of claim 1, further comprising connection means running longitudinally through the plural sensor modules to bring the sensor modules together to create a sealing force between said sensor modules and sealing means.

3. The tool of claim 1, further comprising a mandrel running longitudinally through the plural sensor modules to bring the sensor modules together to create a sealing force between the sensor modules and sealing means.

4. The tool of claim 1 further comprising a separate battery vehicle mechanically and electrically connected to the plural sensor modules.

5. The tool of claim 1 wherein at least some of the sensors are mounted at distal ends of arms that extend away from the sensor modules

6. The tool of claim 1 wherein sensor modules comprise at least two imaging sensors, preferably located diametrically apart.

7. The tool of claim 1 wherein the sensors are one of: MFL, Calipers, EMAT, Ultrasonic, Phased Array Ultrasonic, or optical.

8. The tool of claim 1 wherein mating surfaces of adjoining sensor modules are stackable with a variable rotational offset between them.

9. The tool of claim 8 further comprising an indexer for stacking adjoining sensor modules at one of a selection of fixed rotational offsets.

10. The tool of claim 1, wherein the sensor modules are substantially disc shaped and create a generally cylindrical tool when stacked.

11. The tool of claim 1 wherein each module comprises data storage, sensor driving circuits and communication means to operate independent of other sensor modules.

12. The tool of claim 1 further comprising heat sinks thermally coupling the electronics to an exterior of said sensor modules.

13. The tool of claim 1 wherein the tool comprises at least six sensor modules.

14. A method of performing inline inspection of a pipeline comprising:
selecting a plurality of sensor modules, each module mounted with at least one imaging sensor facing radially outwards;
creating an inline inspection tool by stacking the plurality of sensor modules together with said sensors circumferentially distributed around the inline inspection tool;
sealing adjoining modules to prevent ingress of external fluid into the inline inspection tool;
deploying the inline inspection tool into and through the pipeline; and
autonomously operating electronics within the inline inspection tool to receive and store data from said sensors.

15. The method of claim 14 further comprising swapping one of the sensor modules in the inline inspection tool for another sensor module at a deployment site.

16. The method of claim 14 wherein said sensors are circumferentially distributed around the inline inspection tool by stacking the plurality of sensor modules together with fixed rotational offset between adjoining modules.

17. The method of claim 16 wherein said fixed rotational offset is selected based on the number of sensors used in the tool.

18. The method of claim 14 further comprising inserting a mandrel through the plurality of sensor modules and tightening it against ends of the sensor modules to increase a sealing force between adjoining modules.
